(19) United States
(12) Patent Application Publication
(10) Pub. No.: US 2002/0098815 A1
(43) Pub. Date: Jul. 25, 2002

(54) Adaptive array antenna system and method for determining radio signal direction of adaptive array antenna

(76) Inventors: Toshihiro Hattori, Okazaki-city (JP); Hideyuki Morita, Nishio-city (JP); Akira Tsukamoto, Kariya-city (JP)

Correspondence Address: FISH & RICHARDSON, PC, 4350 LA JOLLA VILLAGE DRIVE, SUITE 500, SAN DIEGO, CA, 92122, US

(21) Appl. No.: 10/014,039

(22) Filed: Dec. 10, 2001

(30) Foreign Application Priority Data
Jan. 22, 2001 (JP) 2001-13550

(51) Int. Cl. H04B 17/02

(52) U.S. Cl. 455/138; 455/137; 455/562

(57) ABSTRACT

Base stations have a plurality of antenna devices and a radio communicating zone, respectively. Each base station transmits respective information signals multiplied with a first complex weight from one antenna device and multiplied with a second complex weight from the other antenna device, when the mobile station is within each of the communication zones. The base stations renew the first and the second complex weights based on the direction of the mobile station. One of the base stations determines the initial values of its first and second complex weights based on a direction information of the mobile station obtained when the mobile station was in the zone of the other base station, upon moving from one zone to the other zone.

### CROSS REFERENCE TO RELATED APPLICATION

This application is based upon and claims the benefit of Japanese Patent Application No. 2001-13550 filed on Jan. 22, 2001, the contents of which are incorporated herein by reference.

### BACKGROUND OF THE INVENTION

The present invention relates to an adaptive array antenna system and method that are capable of determining radio signal direction by communicating between a mobile station and base stations.

An adaptive array antenna system is adopted in a CDMA communicating system, and an adaptive array antenna apparatus is adopted as a base station of the CDMA communicating system. The adaptive array antenna apparatus communicates with a mobile station by radio communication when the mobile station is within a radio communicating zone.

The adaptive array antenna apparatus has at least two antennas. Each antenna transmits a radio signal as an electromagnetic wave that is information signal multiplied with a complex weight. The information signal is transmitted to a direction including the mobile station and is not transmitted to other directions. Therefore, the information signal is transmitted to the mobile station appropriately.

The adaptive array antenna apparatus renews the complex weight in order to transmit the information signal more appropriately. Therefore, the adaptive array antenna apparatus can transmit the information signal to the direction including the mobile station, even if the mobile station moves to another place.

In the adaptive array antenna system, when the mobile station moves to a neighboring radio communicating zone of a neighboring adaptive array antenna apparatus, the neighboring adaptive array antenna apparatus also calculates a complex weight independently and transmits information signal to the direction including the mobile station based on the calculated result.

In this case, however, the complex weight is calculated anew by the neighboring adaptive array antenna apparatus. Thus, the neighboring adaptive array antenna apparatus has to renew the complex weight repeatedly until appropriate complex weigh is calculated. Therefore, its calculation time may become long, and communicating efficiency between the neighboring adaptive array antenna apparatus and the mobile station may be decreased.

### SUMMARY OF THE INVENTION

It is therefore an object of the present invention to provide an adaptive array antenna system and method, which are capable of obviating the above problem.

According to the present invention, an adaptive array antenna system has base stations, each of which has a plurality of antenna devices and a radio communicating zone, and a mobile station. Each base station transmits an information signal multiplied with a first complex weight from one antenna device and multiplied with a second complex weight from the other antenna device. The base stations renew the first and the second complex weights based on the direction of the mobile station. If the mobile station moves from one zone to the other zone, one of the base stations determines initial values of its first and second complex weights based on a direction information of the mobile station obtained when the mobile station was in the zone of the other base station.

### BRIEF DESCRIPTION OF THE DRAWINGS

Other objects, features and advantages of the present invention will be understood more fully from the following detailed description made with reference to the accompanying drawings. In the drawings:

FIG. 1 is a schematic diagram showing general concept according to an embodiment of the present invention;

FIG. 2 is a block diagram showing base stations and a mobile station in the embodiment;

FIG. 3 is a block diagram showing one of the base stations and the mobile station in the embodiment;

FIG. 4 is a schematic diagram showing an information signal, first and second pilot signals in the embodiment;

FIG. 5 is a flow diagram showing a handover processing executed by the base stations and the mobile station in the embodiment; and

FIG. 6 is a schematic diagram showing general concept in the embodiment.

### DETAILED DESCRIPTION OF THE PREFERRED EMBODIMENT

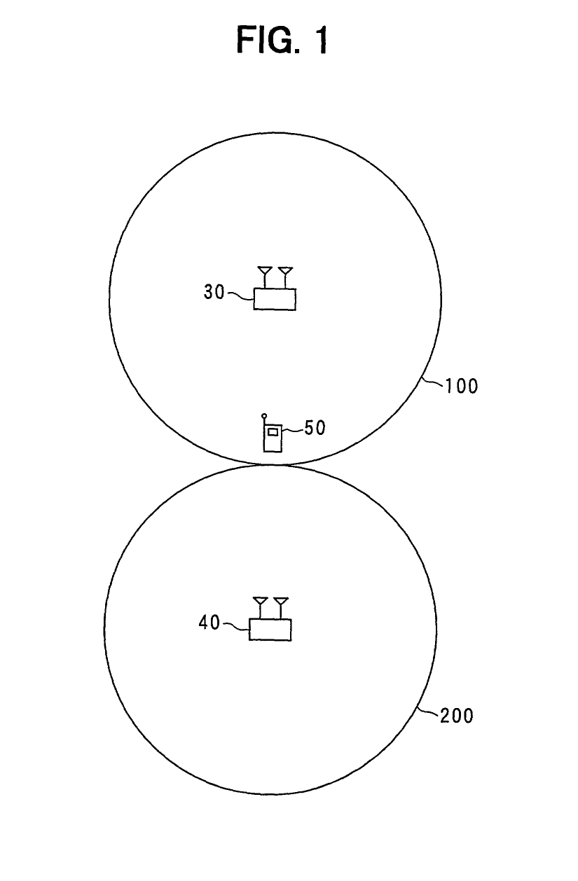

In this embodiment, an adaptive array antenna system is adopted in a CDMA communicating system. As shown in FIG. 1, a CDMA communicating system is equipped with at least two base stations 30, 40. Each of the base stations 30, 40 corresponds to an adaptive array antenna apparatus. Further it is comprised of a mobile station 50 for communicating with one of the base stations 30, 40.

The base station 30 has a radio communicating zone 100 and communicates with the mobile station 50 when the mobile station 50 is within the zone 100. The base station 40 has a radio communicating zone 200, which is neighboring to the zone 100, and communicates with the mobile station 50 when the mobile station 50 is within the zone 200. Thus, when the mobile station 50 moves from the zone 100 to the zone 200, the base station 40 communicates with the mobile station 50 in place of the base station 30.

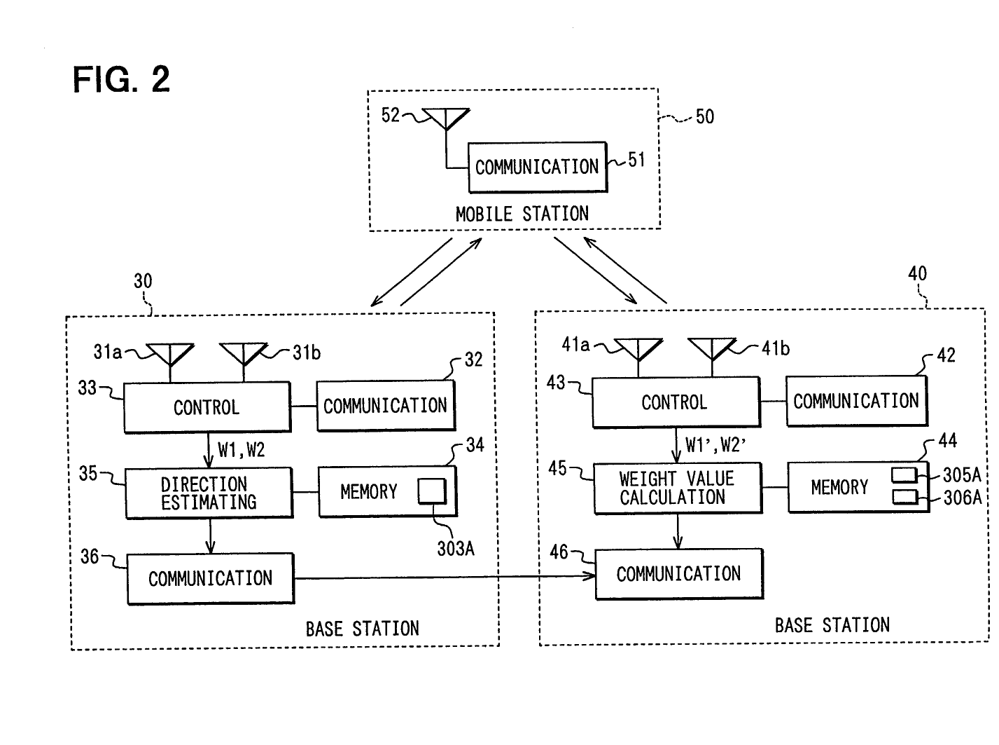

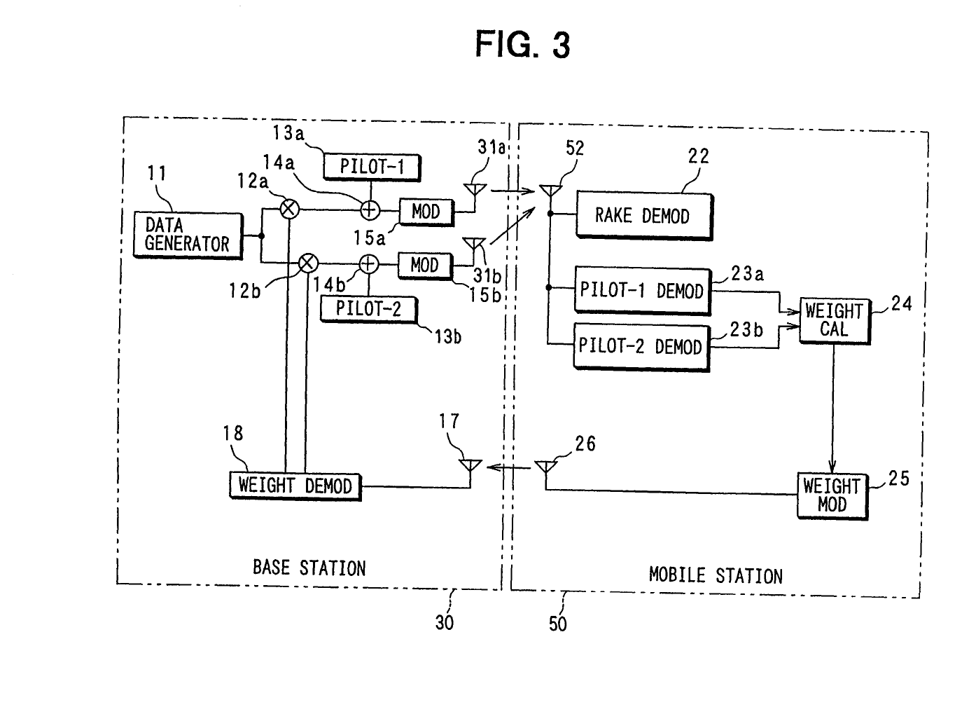

As shown in FIG. 2, the mobile station 50 is equipped with communicator 51 for communicating with the base stations 30, 40 and antenna 52. The base station 30 is equipped with a plurality of antenna devices 31a, 31b, a communication circuit 32 for communicating with the mobile station 50, a control circuit 33 for controlling a radio signal generated by the antenna devices 31a, 31b, a memory 34, a direction estimating circuit 35 and a communication circuit 36 for communicating with the base station 40. For instance, the antenna devices 31a, 31b, the communication circuit 32, the control circuit 33 and the mobile station 50 are constructed as shown in FIG. 3.

As shown in FIG. 3, the communication circuit 32 includes to a transmitting data generator 11. The control circuit 33 includes analog multipliers 12a, 12b, a first pilot (pilot-1) generator 13a, a second pilot (pilot-2) generator 13b, adders 14a, 14b, quadrature modulation devices 15a, 15b, an antenna 17, and a weight demodulation circuit 18.

The mobile station 50 is equipped with a RAKE combine demodulator 22, a first pilot demodulator 23a, a second pilot demodulator 23b, a weight calculation circuit 24, a weight modulation circuit 25 and antenna 26. These are included in the communication circuit 51.

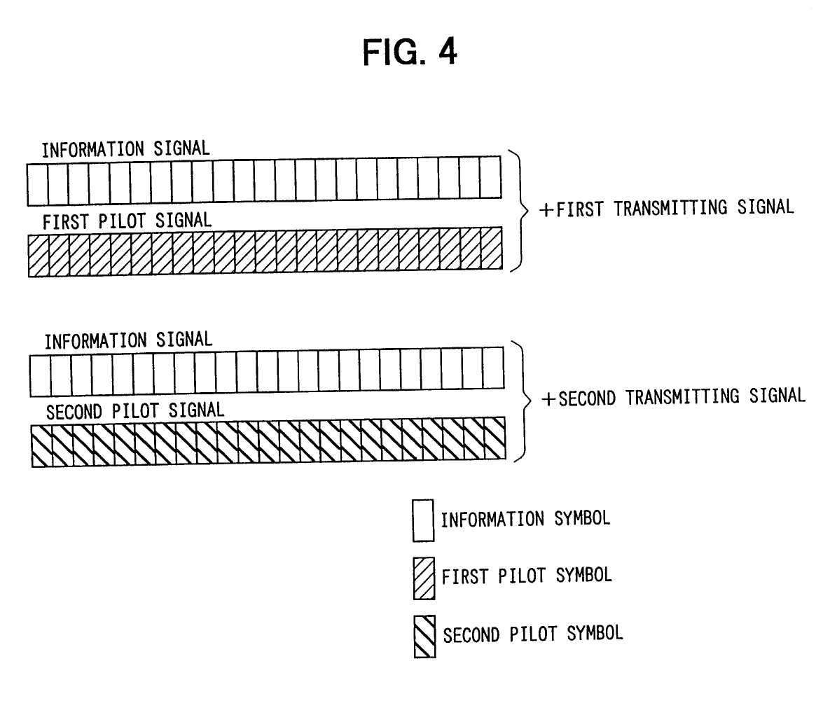

In the base station 30, the transmitting data generator 11 generates information signal executed by a spectrum spreading processing, and outputs it to the analog multipliers 12a, 12b, respectively. Those information signals output to the analog multipliers 12a, 12b are the same complex signals. As shown in FIG. 4, those information signals are comprised of a plurality of information symbols. The analog multiplier 12a multiplies a first complex weight by the information signal, outputs its result as a first multiplication signal. The analog multiplier 12b multiplies a second complex weight by the information signal, outputs its result as a second multiplication signal.

The first and the second pilot generators 13a, 13b generate first and second pilot signals executed by the spectrum spreading processing, and output them to the adders 14a, 14b, respectively. The first and the second pilot signals are complex signals, including identification signals regarding this base station 30. As shown in FIG. 4, the first and the second pilot signals are comprised of a plurality of first and second pilot symbols.

The first and second pilot symbols are different from each other. In the spectrum spreading of the first and the second pilot signals, spreading symbols utilized as the first and the second pilot signals are the same, but they are different from spreading symbols that are utilized in the spectrum spreading of the information signals.

The adder 14a adds the first pilot signal and the information signal, and outputs its result as a first addition signal. The adder 14b adds the second pilot signal and the information signal, and outputs its result as a second addition signal. The quadrature modulation device 15a acquires a first transmitting signal by quadrature modulating the first addition signal with the use of a carrier wave. Thus, the first transmitting signal is output as a radio signal (electromagnetic wave) from the antenna device 31a. The quadrature modulation device 15b acquires a second transmitting signal by quadrature modulating the second addition signal with the use of a carrier wave. Thus, the second transmitting signal is output as a radio signal (electromagnetic wave) from the antenna device 31b.

On the other hand, in the mobile station 50, the antenna 52 receives a synthetic signal of the first and the second transmitting signals from the base station 30. The synthetic signal arrives at the antenna 52 directly without reflection by buildings, etc. and after being reflected by buildings, etc. Thus, the synthetic signal travels through different paths. The RAKE combine demodulator 22 receives the synthetic signal through a plurality of reception paths, acquires the information signal by demodulating and RAKE combining signals received through the reception paths. The first pilot demodulator 23a demodulates the first pilot signal based on the synthetic signal. The second pilot demodulator 23b demodulates the second pilot signal based on the synthetic signal.

The weight calculation circuit 24 calculates phase difference between the first and the second pilot signals and outputs phase difference information indicative of its calculation result. This phase difference information signifies communicating condition between the base station 30 and the mobile station 50. The weight calculation circuit 24 further compares amplitude of the first and the second pilot signals. Thus, the weight calculation circuit 24 outputs amplitude comparison information indicative of its comparison result. The weight modulation circuit 25 modulates the phase difference information and the amplitude comparison information, and outputs its modulated signals from the antenna 26 as a feedback signal to renew the first and the second complex weights in the base station 30.

Further, in the base station 30, the antenna 17 receives the feedback signal and outputs it to the weight demodulation circuit 18. The weight demodulation circuit 18 demodulates the feedback signal and acquires the phase difference information and the amplitude comparison information. Thus, the weight demodulation circuit 18 renews both the first and second complex weights based on the phase difference information and the amplitude comparison information. This renewal is executed so that the first and the second multiplication signals are transmitted in the same amplitude within the zone 100, in the same phase to the direction including the mobile station 50, and in the opposite phase to the other directions.

Therefore, in the direction including the mobile station 50, the first and the second multiplication signals are added with each other and can be demodulated appropriately. On the other hand, in the other directions, the first and the second multiplication signals are compensated with each other and are hardly transmitted. It indicates that transmitting-beam's (electric wave's) direction of the first and the second transmitting signals, that is, the first and the second information signals, are pointed to the mobile station 50. In order to set the transmitting directions more accurately, the first and the second complex weights are adopted.

As mentioned above, the communication circuit 32 transmits the information signal to the control circuit 33. The control circuit 33 outputs the first transmitting signal from the antenna device 31a, outputs the second transmitting signal from the antenna device 31b, and renews the first and the second complex weights W1, W2 so that the first and the second multiplication signals are transmitted to the mobile station 50 in the same phase.

Further, the control circuit 33 outputs final renewal values of the first and the second complex weights W1, W2 at handover timing, that is, the time when the mobile station 50 moves form the zone 100 to the zone 200.

The memory 34 has a direction database 303A. This database 303A stores a plurality of predetermined candidate sites for the directions including the mobile station 50 that corresponds to each of the first and the second complex weights W1, W2. The direction estimating circuit 35 is programmed to search estimated direction information, which is indicative of the direction toward the mobile station 50 from the base station 30, based on the data of the database 303A and the final values of the first and the second complex weights W1, W2. Thus, the memory 34 memorizes the estimated direction information.

Here, the relationship between each of the first and the second complex weights W1, W2 and each of the candidate sites for the directions are determined by not only the first and the second complex weights W1, W2, but also characteristics of the antenna devices 31a, 31b. This is because the transmitting-beam's direction is also variable due to the characteristics of the antenna devices 31a, 31b, for example, distance (disposition of the antenna devices 31a, 31b), directivity or the like.

The communication circuit 36 transmits the estimated direction information to the base station 40 through a wire.

The base stations 40 is equipped with a plurality of antenna devices 41a, 41b, a communication circuit 42 for communicating with the mobile station 50, a control circuit 43 for controlling a radio signal generated by the antenna devices 41a, 41b, a memory 44, an initial weight value calculation circuit 45 for determining a initial weight value of the base station 40, and a communication circuit 46 for communicating with the base station 30. The antenna devices 41a, 41b are the same as the antenna devices 31a, 31b. The communication circuit 42 has basically the same construction and acts the same way as the communication circuit 32. The control circuit 43 has basically the same construction and acts the same way as the control circuit 33. The communication circuit 46 receives the estimated direction information from the communication circuit 36 of the base station 30.

The memory 44 has a disposition database 305A and a weight database 306A. The disposition database 305A stores a plurality of predetermined candidate sites for the directions including the mobile station 50 that corresponds to each of the estimated direction information. The initial weight value calculation circuit 45 is programmed to discriminate new direction information, which is indicative of the direction toward the mobile station 50 from the base station 40, based on the data in the database 305A and the estimated direction information received at the communication circuit 46. Thus, the memory 44 memorizes the new direction information. Here, the relationship between each of the estimated information and each of the new direction information are determined by predetermined disposition information relating to each of the base stations 30, 40.

Further, the weight database 306A stores the initial weight values of a first and a second complex weights W1′, W2′ that corresponds to each of the new direction information. The initial weight value calculation circuit 45 is programmed to search the initial weight values of the first and the second complex weights W1′, W2′ based on the data of the database 306A and the new information discriminated by itself. Thus, the memory 44 memorizes the initial weight values of the first and the second complex weights W1′, W2′.

Here, the relationship between each of the initial weight values of the first and the second complex weights W1′ W2′ and each of the new direction information are determined by not only the new direction information, but also characteristics of the antenna devices 41a, 41b. This is because the transmitting-beam's direction is also variable by the characteristics of the antenna devices 41a, 41b, for example, distance (disposition of the antenna devices 41a, 41b), directivity or the like.

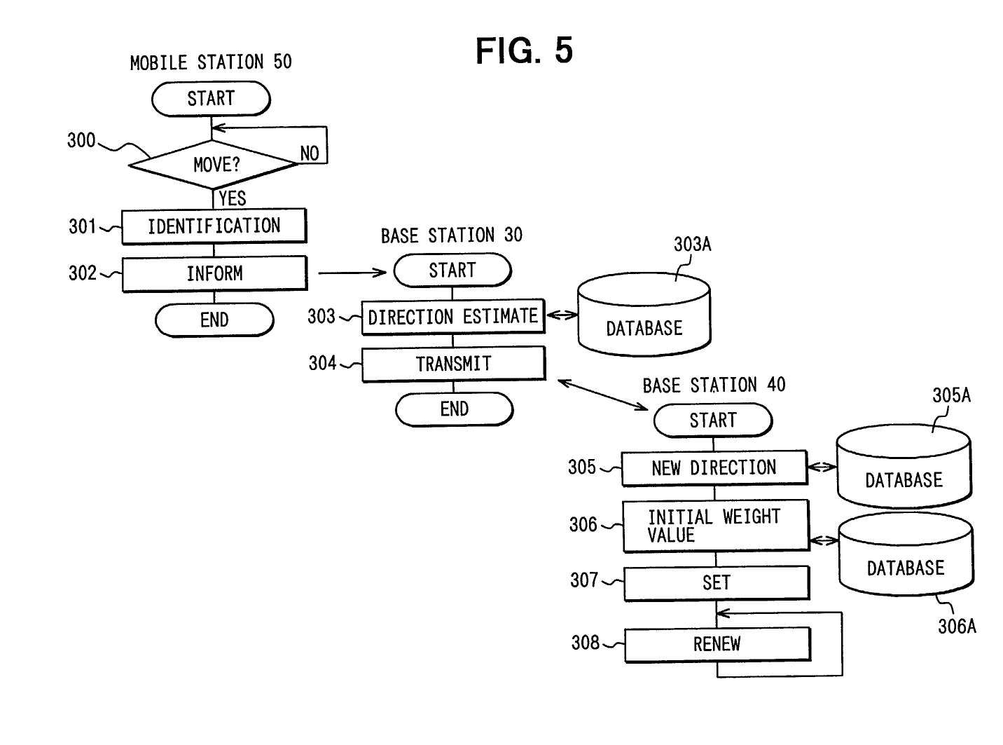

The mobile station 50 and the base stations 30, 40 are programmed to execute each routines showing in FIG. 5. It is assumed here that the mobile station 50 moves from the zone 100 to the zone 200.

As shown in FIG. 5, at step 300, the mobile station 50 compares reception condition (e.g., reception electric intensity) between the base stations 30, 40. The mobile station 50 determines that it has moved to the zone 200, when the reception condition from the base station 40 is better than that of the base station 30. Namely, the mobile station 50 determines that the base station 30 is a former point of the handover and the base station 40 is a next point of the handover. Thus, the mobile station 50 executes steps 301, 302 as a handover processing.

At step 301, the mobile station 50 acquires an identification signal of the base station 40 based on the first and the second pilot signals from the base station 40. Then, at step 302, the mobile station 50 informs the identification signal regarding the base station 40 to the base station 30 as the former point of the handover. Therefore, the base station 30 executes the handover processing.

In the base station 30, the control circuit 33 receives the identification signal regarding the base station 40 via antenna devices 31a, 31b, outputs its identification signal to the communication circuit 36. Whereupon, the control circuit 33 stops renewal of the first and the second complex weights W1, W2, outputs the first and the second complex weights W1, W2 to the direction estimating circuit 35 as the final renewal values.

At step 303, the direction estimation circuit 35 searches estimated direction information corresponding to the final renewal values of the first and the second complex weights W1, W2 by using the direction database 303A. The communication circuit 36 determines that the base station 40 is the next point of the handover based on the identification signal from the control circuit 33. Thus, at step 304, the communication circuit 36 transmits the estimated direction information to the base station 40 through the wire. Therefore, the base station 40 executes the handover processing.

In the base station 40, at step 305, the initial weight value calculation circuit 45 receives the estimated direction information via the communication circuit 46. The initial weight value calculation circuit 45 discriminates the new direction information of the mobile station 50 corresponding to the estimated information based on the database 305A. Further, at steps 306 and 307, the initial weight value calculation circuit 45 searches the initial weight values of the first and the second complex weights W1′, W2′ corresponding to the new direction information based on the database 306A, and sets them in the control circuit 43. Therefore, at step 308, the control circuit 43 renews the first and the second complex weights W1′, W2′ based on the initial weight values.

In this embodiment, for example, if the base station 30 exists at north side of the base station 40, the estimated direction information is informed as follows. It is assumed that non-directivity antennas are adopted as the antenna devices 31a, 31b, 41a and 41b. The distance between the antenna devices 31a and 31b, 41a and 41b is half of wavelength λ, which is wavelength of carrier wave of the first and the second transmitting signals from the antenna devices 31a, 31b, 41a and 41b. Thus, the transmitting-beam's direction from the antenna devices 31a, 31b, 41a and 41b can be set to a limited direction. For instance, the transmitting-beam turns north and south or west and east.

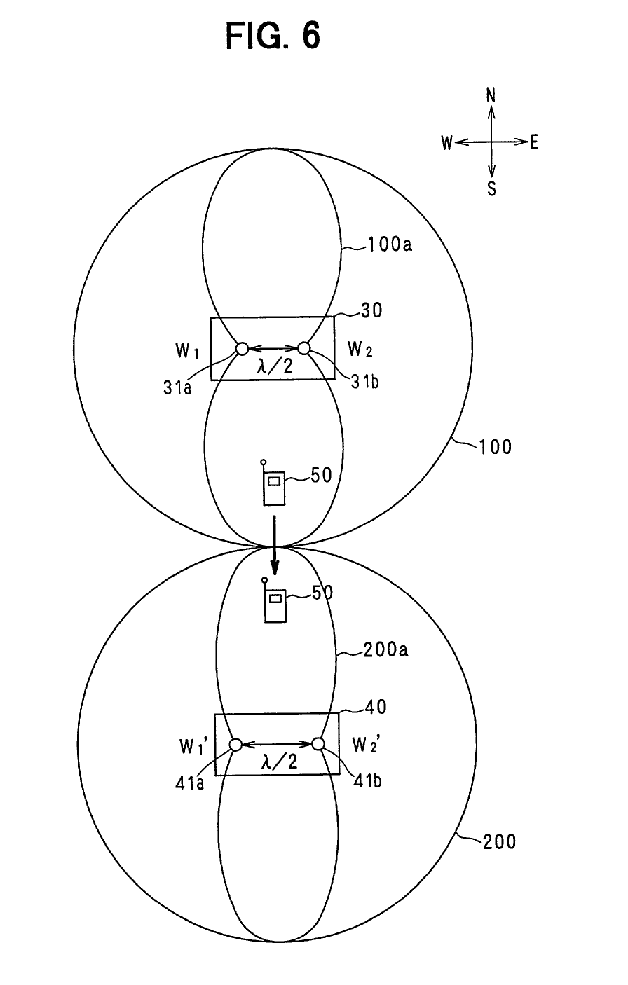

As shown in FIG. 6, the mobile station 50 exists at south side of the base station 30. Therefore, the control circuit 33 turns the transmitting-beam to north and south based on the renewal of the first and the second complex weights W1, W2.

Next, when the mobile station 50 moves from the zone 100 to the zone 200, the control circuit 33 stops renewal of the first and the second complex weights W1, W2, outputs its final renewal values to the direction estimating circuit 35. The direction estimating circuit 35 searches the estimated direction information corresponding to the final renewal values. Thus, north and south information is searched as the estimated direction information. The communication circuit 36 informs the estimated direction information indicative of north and south to the base station 40 as the next point of the handover.

On the other hand, in the base station 40, the initial weight value calculation circuit 45 receives the north and south information. The initial weight value calculation circuit 45 searches the initial weight values of the first and the second complex weights W1′, W2′. Then, because of the base station 40 existing at the south side of the base station 30, north is estimated as the new direction information by the initial weight value calculation circuit 45. Therefore, the control circuit 43 controls the transmitting-beam so that it turns to north. Thus, the transmitting-beam is transmitted to north and south from the antenna devices 41a, 41b.

As described above, the base station 40 calculates the initial weight values of the first and the second complex weights W1′, W2′ based on the estimated direction information from the base station 30. Therefore, its calculation time can be shortened, and communicating efficiency between the base station 40 and the mobile station 50 can be increased.

In this embodiment, the base stations 30, 40 may have more than two antenna devices. Directivity antennas can be utilized as the antenna devices 31a, 31b, 41a and 41b. The base station 30 can adopt one of the first and the second complex weights W1, W2. The base station 40 can adopt one of the first and the second complex weights W1′, W2′.

What is claimed is:

1. An adaptive array antenna system comprising:
a mobile station; and
a first and a second adaptive array antenna apparatuses, each of which has at least a first and a second antenna devices and a radio communicating zone,
wherein first and the second adaptive array antenna apparatuses transmit an information signal multiplied with a first weight from each of the first antenna devices and the information signal multiplied with a second weight from each of the second antenna devices, when the mobile station is within each of the radio communicating zones,
wherein the first and the second adaptive array antenna apparatuses renew each of the first and the second weights based on the direction of the mobile station, and
wherein the second adaptive array antenna apparatuses determine the initial values of its first and second weights based on a direction information of the mobile station which was in the zone of the first adaptive array antenna apparatus, when the mobile station moves from the zone of the first adaptive array antenna apparatus to the zone of the second adaptive array antenna apparatus.

2. An adaptive array antenna system as in claim 1,
wherein the first adaptive array antenna apparatus transmits the direction information to the second adaptive array antenna apparatus, when the mobile station moves from the zone of the first adaptive array antenna apparatus to the zone of the second adaptive array antenna apparatus.

3. An adaptive array antenna system as in claim 2,
wherein the first adaptive array antenna apparatus stops to renew its first and the second weights, transmits the direction information, which corresponds to final renewal values of its first and second weights, to the second adaptive array antenna apparatus.

4. An adaptive array antenna system as in claim 3,
wherein the second adaptive array antenna apparatus determines the initial values of the first and second weights based on both the direction information of the mobile station and direction information indicative of direction of the first adaptive array antenna apparatus.

5. An adaptive array antenna system as in claim 3,
wherein the second adaptive array antenna apparatus determines the initial values of the first and second weights based on a characteristics of its first and second antenna devices.

6. An adaptive array antenna system as in claim 5,
wherein the second adaptive array antenna apparatus renews the first and the second weights based on the initial values of the first and the second weights which are determined by using the direction information.

7. An adaptive array antenna communicating method for a communication system having a first and a second adaptive array antenna apparatuses each of which is equipped with at least a first and a second antenna devices defining a radio communicating zone, and a mobile station, the adaptive array antenna communicating method comprising steps of:
transmitting, by the first and the second adaptive array antenna apparatuses, an information signal multiplied with a first weight from each of the first antenna devices and the information signal multiplied with a second weight from each of the second antenna devices, when the mobile station is within each of the radio communicating zones;
renewing, by the first and the second adaptive array antenna apparatuses, each of the first and the second weights based on the direction of the mobile station; and
determining, by the second adaptive array antenna apparatus, determines the initial values of its first and second weights based on a direction information of the mobile station which was in the zone of the first adaptive array antenna apparatus, when the mobile station moves from the zone of the first adaptive array antenna apparatus to the zone of the second adaptive array antenna apparatus.

8. An adaptive array antenna communicating method as claim in 7, further comprising a step of:
transmitting, by the first adaptive array antenna apparatus, the direction information to the second adaptive array antenna apparatus, when the mobile station moves from the zone of the first adaptive array antenna apparatus to the zone of the second adaptive array antenna apparatus.

9. An adaptive array antenna communicating method as claim in 7, further comprising a step of:
stopping, by the first adaptive array antenna apparatus, renewing its first and the second weights,
wherein the transmitting step transmits the direction information corresponding to final renewal values of its first and second weights, to the second adaptive array antenna apparatus.
